(19) United States
(12) Patent Application Publication
(10) Pub. No.: US 2024/0184783 A1
(43) Pub. Date: Jun. 6, 2024

(54) Host System Failover via Data Storage Device Configured to Provide Memory Services

(71) Applicant: Micron Technology, Inc., Boise, ID (US)

(72) Inventor: Luca Bert, San Jose, CA (US)

(21) Appl. No.: 18/519,565

(22) Filed: Nov. 27, 2023

Related U.S. Application Data
(60) Provisional application No. 63/385,951, filed on Dec. 2, 2022.

(51) Int. Cl. G06F 16/2455; G06F 16/22

(52) U.S. Cl. CPC G06F 16/24552; G06F 16/2282

(57) ABSTRACT

Host system failover via a memory sub-system storing in-memory data for database operations. Over a connection from a host interface of the memory sub-system, a first portion of the memory sub-system can be attached to a first host system as a memory device accessible via a first protocol; and a second portion of the memory sub-system can be attached to the first host system as a storage device accessible via a second protocol. A database manager running in the first host system can store the in-memory data in the memory device and store a persistent copy of database records in the storage device. When the first host system fails, the memory sub-system can be reconnected to a second host system to use the in-memory data for continued database operations.

### RELATED APPLICATIONS

The present application claims priority to Prov. U.S. Pat. App. Ser. No. 63/385,951 filed Dec. 2, 2022, the entire disclosures of which application are hereby incorporated herein by reference.

### TECHNICAL FIELD

At least some embodiments disclosed herein relate to memory systems in general, and more particularly, but not limited to memory systems configured to be accessible for memory services and storage services.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a memory sub-system in accordance with some embodiments of the present disclosure.

FIG. 2 shows a memory sub-system configured to offer both memory services and storage services to a host system over a physical connection according to one embodiment.

FIG. 3 illustrates the use of memory services provided by a memory sub-system to track write-ahead log entries for database records stored in the memory sub-system according to one embodiment.

FIG. 4 shows the processing of log entries according to one embodiment.

FIG. 5 illustrates the use of memory services provided by a memory sub-system to store a stored string table for changes in database records stored in the memory sub-system according to one embodiment.

FIG. 6 shows a method to track changes to database records according to one embodiment.

FIG. 7 shows an example of host system failover based on memory services provided by a memory sub-system according to one embodiment.

FIG. 8 and FIG. 9 illustrate an active host system taking over the database operations of another host system using in-memory change data stored in a memory sub-system according to one embodiment.

FIG. 10 shows a method to transfer database operations between host systems according to one embodiment.

### DETAILED DESCRIPTION

At least some aspects of the present disclosure are directed to tracking changes to data stored in a memory sub-system using memory services provided by the memory sub-system over a physical connection. The memory sub-system also uses the physical connection to provide storage services for the storage of the data in the memory sub-system. Storing in-memory change data of a database using the memory services provided by the memory sub-system can facilitate the transfer of database operations from one host system to another.

For example, a host system and a memory sub-system (e.g., a solid-state drive (SSD)) can be connected via a physical connection according to a computer component interconnect standard of compute express link (CXL). Compute express link (CXL) includes protocols for storage access (e.g., cxl.io), and protocols for cache-coherent memory access (e.g., cxl.mem and cxl.cache). Thus, a memory sub-system can be configured to provide both storage services and memory services to the host system over the physical connection using compute express link (CXL).

A typical solid-state drive (SSD) is configured or designed as a non-volatile storage device that preserves the entire set of data received from a host system in an event of unexpected power failure. The solid-state drive can have volatile memory (e.g., SRAM or DRAM) used as a buffer in processing storage access messages received from a host system (e.g., read commands, write commands). To prevent data loss in a power failure event, the solid-state drive is typically configured with an internal backup power source such that, in the event of power failure, the solid-state drive can continue operations for a limited period of time to save the data, buffered in the volatile memory (e.g., SRAM or DRAM), into non-volatile memory (e.g., NAND). When the limited period of time is sufficient to guarantee the preservation of the data in the volatile memory (e.g., SRAM or DRAM) during a power failure event, the volatile memory as backed by the backup power source can be considered non-volatile from the point of view of the host system. Typical implementations of the backup power source (e.g., capacitors, battery packs) limit the amount of volatile memory (e.g., SRAM or DRAM) configured in the solid-state drive to preserve the non-volatile characteristics of the solid-state drive as a data storage device. When functions of such volatile memory are implemented via fast non-volatile memory, the backup power source can be eliminated from the solid-state drive.

When a solid-state drive is configured with a host interface that supports the protocols of compute express link, a portion of the fast, volatile memory of the solid-state drive can be optionally configured to provide cache-coherent memory services to the host system. Such memory services can be accessible via load/store instructions executed in the host system at a byte level (e.g., 64B or 128B) over the connection of computer express link. Another portion of the volatile memory of the solid-state drive can be reserved for internal use by the solid-state drive as a buffer memory to facilitate storage services to the host system. Such storage services can be accessible via read/write commands provided by the host system at a logical block level (e.g., 4 KB) over the connection of computer express link.

When such a solid-state drive (SSD) is connected via a computer express link connection to a host system, the solid-state drive can be attached and used both as a memory device and a storage device to the host system. The storage device provides a storage capacity addressable by the host system via read commands and write commands at a block level for data records of a database; and the memory device provides a physical memory addressable by the host system via load instructions and store instructions at a byte level for changes to data records of the database.

Changes to a database can be tracked via write-ahead logs (WAL), simple sorted tables (SST), etc. Changes can be written to a non-volatile storage device before the changes are applied the database. The recorded changes in the non-volatile storage device can be used to facilitate reconstructions of in-memory changes in case of a crash.

A write command can be used to save a block of data at a storage location identified by a logical block address (LBA). Such a block of data is typically configured to have a predetermined block size of 4 KB size. However, changes to a database can be typically tracked using data (e.g., write-ahead log entries, key value pairs added to a table in simple sorted tables) having sizes smaller than the predetermined block size of the data at a logical block address. For example, change log entries can have sizes from a few bytes to a few hundreds of bytes. It is inefficient to partially modify a block of data at a logical block address to store a small amount of change data, or to use a full block to store the small amount of change data.

It is advantageous for a host system to use the memory services provided by the solid-state drive to buffer the change data (e.g., write-ahead log entries, simple sorted tables). When the accumulated change data has a size larger than the predetermined block size for logical block addressing, a data block can be packed and written to a logical block address to store the change data into the non-volatile storage device provided by the solid-state drive.

The memory space provided by the solid-state drive over a computer express link connection can be considered non-volatile from the point of view of the host system. The memory allocated by the solid-state drive to provide the memory services over the computer express link connection can be implemented via non-volatile memory, or via volatile memory backed with a backup power supply. The backup power supply is configured to be sufficient to guarantee that, in the event of disruption to the external power supply to the solid-state drive, the solid-state drive can continue operations to save the data from the volatile memory to the non-volatile storage capacity of the solid-state drive. Thus, in the event of unexpected power disruption, the data in the memory space provided by the solid-state drive (e.g., accumulated change data) is preserved and not lost.

After the changes to the database have been committed persistently into a storage device, the data configured to identify the changes may not be in need any more. Thus, the change data can be discarded. If the change data is stored in the memory space provided by the solid-state drive, the change data can be erased from the memory space to provide room for accumulating further data for the identification of further changes, without a need to write the change data to a file in a storage device (e.g., attached by the solid-state drive). For example, a circular log can be implemented in the memory space provided by the solid-state drive. The oldest log entries configured to identify changes can be overwritten by the newest log entries, after the oldest log entries have been written into the file in the storage device.

In some implementations, the solid-state drive can write change data, from a memory portion of its memory resources allocated to provided memory services to the host system, to a storage portion of its memory resources allocated to provide storage services to the host system. The writing can be performed without separately retrieving the change data from the host system, since the change data is already in the faster memory of the solid-state drive. Such an arrangement avoids the need for the change data to be communicated repeatedly from the host system to the solid-state drive for storing in the memory portion and for writing into the storage portion.

It is advantageous to configure a computing system to have multiple host systems operable to independently perform database operations.

For example, when one of the host systems fails, another host system can take over the operations previously assigned to the failed host system.

For example, a computing system can be configured with a backup host system. When an active host system performs database operations, its in-memory changes to a database can be recorded in the memory device attached by a solid-state drive that also attaches a storage device to the active host system for persistent storage of the records of the database. Since the active host system can use the memory device to store in-memory data about the database that has not yet been committed to the storage device, both the in-memory data and the persistent records of the database are preserved in the solid-state drive. When the active host system fails, the backup host system can continue the database operations from where the active host system has failed. The backup host system can use the in-memory data and the persistent records of the database in the solid-state drive to start database operations from a state that is the same as, or closest to, the state when the active host system fails. Thus, the delay and loss caused by the failure of the active host system can be reduced or minimized.

In some implementations, a cross mirroring technique can be used to replicate in-memory content in multiple host systems. For example, when a host system writes data into its dynamic random access memory (DRAM), the data can be automatically copied via a remote direct memory access (RDMA) network to the dynamic random access memory of another host system. Thus, when the host system fails, the in-memory content of the failed host system is available in the dynamic random access memory of another host system, which can continue the operations that were previously assigned to the failed host system.

Alternatively, instead of replicating the in-memory content from the dynamic random access memory of a host system to the dynamic random access memory of another host system, the in-memory content can be replicated from the dynamic random access memory of the host system to a memory device attached by a solid-state drive connected to the host system via a computer express link connection. Optionally, multiple host systems can share the service of the solid-state drive; and when one host system fails, another host system can use the in-memory content of the failed host system to continue operations.

Optionally, a host system can be configured to perform database operations using the memory device attached over a computer express link connection by a solid-state drive to the host system, instead of using its local dynamic random access memory. Thus, the state of the host system in performing the database operations can be preserved automatically in the solid-state drive. Another system can take over the database operations of the host system by attaching the memory device offered by the solid-state drive for use in database operations and starting from the state preserved in the solid-state drive. Host system failover, or hot swap, can be performed with reduced or minimized delay. Replication of in-memory content from the dynamic random access memory of the host system (e.g., to another host system, or to a solid-state drive) can be eliminated.

For example, a host system can be connected via a computer express link connection to a solid-state drive. The host system can be configured to use the storage services of the solid-state drive to store a persistent copy of database records managed by the host system. Further the host system can be configured to use the memory services of the solid-state drive to store data identifying in-memory changes to the persistent copy (e.g., in the form of write-ahead log entries, simple sorted tables) and other in-memory data related to the operations of the database (e.g., in-memory cache of new or modified database records). When the solid-state drive is reconnected (logically or physically) to a replacement host system, the persistent copy of the database records, the data identifying in-memory changes to the persistent copy, and other in-memory data related to the operations of the database become available to the replacement host system in a same way as being available to the previous host system that is being replaced. Thus, the replacement host system can substitute the previous host system with minimum interruption and delay. In some implementations, the solid-state drive can have two ports that are pre-connected to the two host systems respectively. An active host system can use the solid-state drive through one of the ports for normal operations, while the replacement host system can be inactive in using the solid-state drive through the other port. When the active host system fails, the replacement host system can be active to continue the operations of the failed host system in using the existing connection to one of the ports without changes to the physical connections between the host systems and the solid-state drive.

It is advantageous for a host system to use a communication protocol to query the solid-state drive about the memory attachment capabilities of the solid-state drive, such as whether the solid-state drive can provide cache-coherent memory services, what is the amount of memory that the solid-state drive can attach to the host system in providing memory services, how much of the memory attachable to provide the memory services can be considered non-volatile (e.g., implemented via non-volatile memory, or backed with a backup power source), what is the access time of the memory that can be allocated by the solid-state drive to the memory services, etc.

The query result can be used to configure the allocation of memory in the solid-state drive to provide cache-coherent memory services. For example, a portion of fast memory of the solid-state drive can be provided to the host system for cache coherent memory accesses; and the remaining portion of the fast memory can be reserved by the solid-state drive for internal. The partitioning of the fast memory of the solid-state drive for different services can be configured to balance the benefit of memory services offered by the solid-state drive to the host system and the performance of storage services implemented by the solid-state drive for the host system. Optionally, the host system can explicitly request the solid-state drive to carve out a requested portion of its fast, volatile memory as memory accessible over a connection, by the host system using a cache coherent memory access protocol according to computer express link.

For example, when the solid-state drive is connected to the host system to provide storage services over a connection of computer express link, the host system can send a command to the solid-state drive to query the memory attachment capabilities of the solid-state drive.

For example, the command to query memory attachment capabilities can be configured with a command identifier that is different from a read command; and in response, the solid-state drive is configured to provide a response indicating whether the solid-state drive is capable of operating as a memory device to provide memory services accessible via load instructions and store instructions. Further, the response can be configured to identify an amount of available memory that can be allocated and attached as the memory device accessible over the computer express link connection. Optionally, the response can be further configured to include an identification of an amount of available memory that can be considered non-volatile by the host system and be used by the host system as the memory device. The non-volatile portion of the memory device attached by the solid-state drive can be implemented via non-volatile memory, or volatile memory supported by a backup power source and the non-volatile storage capacity of the solid-state drive.

Optionally, the solid-state drive can be configured with more volatile memory than an amount backed by its backup power source. Upon disruption in the power supply to the solid-state drive, the backup power source is sufficient to store data from a portion of the volatile memory of the solid-state drive to its storage capacity, but insufficient to preserve the entire data in the volatile memory to its storage capacity. Thus, the response to the memory attachment capability query can include an indication of the ratio of volatile to non-volatile portions of the memory that can be allocated by the solid-state drive to the memory services. Optionally, the response can further include an identification of access time of the memory that can be allocated by the solid-state drive to cache-coherent memory services. For example, when the host system requests data via a cache coherent protocol over the compute express link from the solid-state drive, the solid-state drive can provide the data in a time period that is not longer than the access time.

Optionally, a pre-configured response to such a query can be stored at a predetermined location in the storage device attached by the solid-state drive to the host system. For example, the predetermined location can be at a predetermined logical block address in a predetermined namespace. For example, the pre-configured response can be configured as part of the firmware of the solid-state drive. The host system can use a read command to retrieve the response from the predetermined location.

Optionally, when the solid-state drive has the capability of functioning as a memory device, the solid-state drive can automatically allocate a predetermined amount of its fast, volatile memory as a memory device attached over the computer express link connection to the host system. The predetermined amount can be a minimum or default amount as configured in a manufacturing facility of solid-state drives, or an amount as specified by configuration data stored in the solid-state drive. Subsequently, the memory attachment capability query can be optionally implemented in the command set of the protocol for cache-coherent memory access (instead of the command set of the protocol for storage access); and the host system can use the query to retrieve parameters specifying the memory attachment capabilities of the solid-state drive. For example, the solid-state drive can place the parameters into the memory device at predetermined memory addresses; and the host can retrieve the parameters by executing load commands with the corresponding memory addresses.

It is advantageous for a host system to customize aspects of the memory services of the memory sub-system (e.g., a solid-state drive) for the patterns of memory and storage usages of the host system.

For example, the host system can specify a size of the memory device offered by the solid-state drive for attachment to the host system, such that a set of physical memory addresses configured according to the size can be addressable via execution of load/storage instructions in the processing device(s) of the host system.

Optionally, the host system can specify the requirements on time to access the memory device over the compute express link (CXL) connection. For example, when the cache requests to access a memory location over the connection, the solid-state drive is required to provide a response within the access time specified by the host system in configuring the memory services of the solid-state drive.

Optionally, the host system can specify how much of the memory device attached by the solid-state drive is required to be non-volatile such that when an external power supply to the solid-state drive fails, the data in the non-volatile portion of the memory device attached by the solid-state drive to the host system is not lost. The non-volatile portion can be implemented by the solid-state drive via non-volatile memory, or volatile memory with a backup power source to continue operations of copying data from the volatile memory to non-volatile memory during the disruption of the external power supply to the solid-state drive.

Optionally, the host system can specify whether the solid-state drive is to attach a memory device to the host system over the compute express link (CXL) connection.

For example, the solid-state drive can have an area configured to store the configuration parameters of the memory device to be attached to the host system via the compute express link (CXL) connection. When the solid-state drive reboots, starts up, or powers up, the solid-state drive can allocate, according to the configuration parameters stored in the area, a portion of its memory resources as a memory device for attachment to the host system. After the solid-state drive configures the memory services according to the configuration parameters stored in the area, the host system can access, via the cache, through execution of load instructions and store instructions identifying the corresponding physical memory addresses. The solid-state drive can configure its remaining memory resources to provide storage services over the compute express link (CXL) connection. For example, a portion of its volatile random access memory can be allocated as a buffer memory reserved for the processing device(s) of the solid-state drive; and the buffer memory is inaccessible and non-addressable to the host system via load/store instructions.

When the solid-state drive is connected to the host system via a computer express link connection, the host system can send commands to adjust the configuration parameters stored in the area for the attachable memory device. Subsequently, the host system can request the solid-state drive to restart to attach, over the computer express link to the host system, a memory device with memory services configured according to the configuration parameters.

For example, the host system can be configured to issue a write command (or store commands) to save the configuration parameters at a predetermined logical block address (or predetermined memory addresses) in the area to customize the setting of the memory device configured to provide memory services over the computer express link connection.

Alternatively, a command having a command identifier that is different from a write command (or a store instruction) can be configured in the read-write protocol (or in the load-store protocol) to instruct the solid-state drive to adjust the configuration parameters stored in the area.

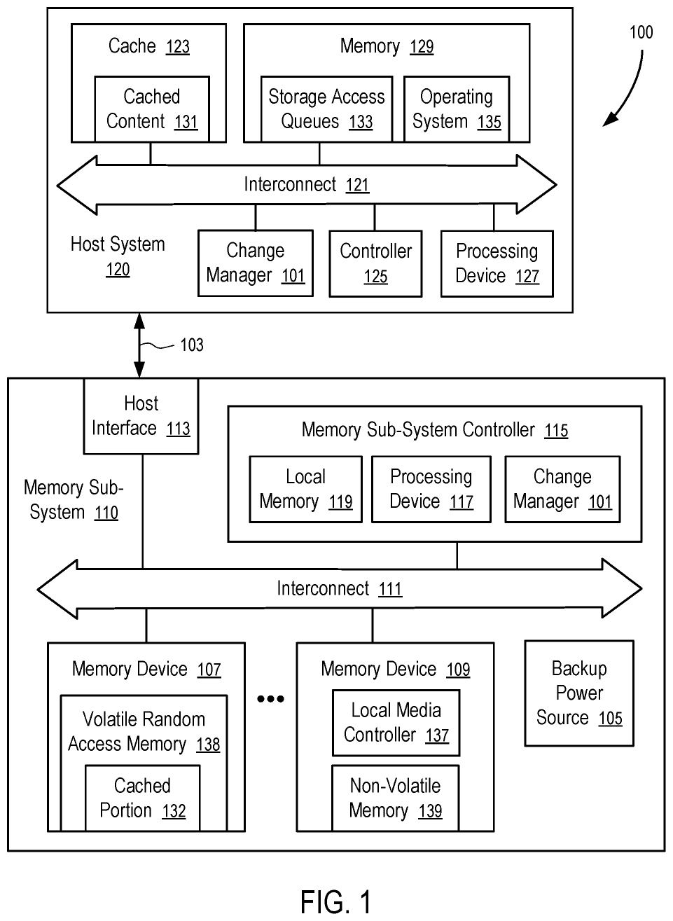

FIG. 1 illustrates an example computing system 100 that includes a memory sub-system 110 in accordance with some embodiments of the present disclosure. The memory sub-system 110 can include computer-readable storage media, such as one or more volatile memory devices (e.g., memory device 107), one or more non-volatile memory devices (e.g., memory device 109), or a combination of such.

In FIG. 1, the memory sub-system 110 is configured as a product of manufacture (e.g., a solid-state drive), usable as a component installed in a computing device.

The memory sub-system 110 further includes a host interface 113 for a physical connection 103 with a host system 120.

The host system 120 can have an interconnect 121 connecting a cache 123, a memory 129, a memory controller 125, a processing device 127, and a change manager 101 configured to use the memory services of the memory sub-system 110 to accumulate changes for storage in the storage capacity of the memory sub-system 110.

The change manager 101 in the host system 120 can be implemented at least in part via instructions executed by the processing device 127, or via logic circuit, or both. The change manager 101 in the host system 120 can use a memory device attached by the memory sub-system 110 to the host system 120 to store changes to a database, before the changes are written into a file in a storage device attached by the memory sub-system 110 to the host system 120. Optionally, the change manager 101 in the host system 120 is implemented as part of the operating system 135 of the host system 120, a database manager in the host system 120, or a device driver configured to operate the memory sub-system 110, or a combination of such software components.

The connection 103 can be in accordance with the standard of compute express link (CXL), or other communication protocols that support cache-coherent memory access and storage access. Optionally, multiple physical connections 103 are configured to support cache-coherent memory access communications and support storage access communications.

The processing device 127 can be a microprocessor configured as a central processing unit (CPU) of a computing device. Instructions (e.g., load instructions, store instructions) executed in the processing device 127 can access memory 129 via the memory controller (125) and the cache 123. Further, when the memory sub-system 110 attaches a memory device over the connection 103 to the host system, instructions (e.g., load instructions, store instructions) executed in the processing device 127 can access the memory device via the memory controller (125) and the cache 123, in a way similar to the accessing of the memory 129.

For example, in response to execution of a load instruction in the processing device 127, the memory controller 125 can convert a logical memory address specified by the instruction to a physical memory address to request the cache 123 for memory access to retrieve data. For example, the physical memory address can be in the memory 129 of the host system 120, or in the memory device attached by the memory sub-system 110 over the connection 103 to the host system 120. If the data at the physical memory address is not already in the cache 123, the cache 123 can load the data from the corresponding physical address as the cached content 131. The cache 123 can provide the cached content 131 to service the request for memory access at the physical memory address.

For example, in response to execution of a store instruction in the processing device 127, the memory controller 125 can convert a logical memory address specified by the instruction to a physical memory address to request the cache 123 for memory access to store data. The cache 123 can hold the data of the store instruction as the cached content 131 and indicate that the corresponding data at the physical memory address is out of date. When the cache 123 needs to vacate a cache block (e.g., to load new data from different memory addresses, or to hold data of store instructions of different memory addresses), the cache 123 can flush the cached content 131 from the cache block to the corresponding physical memory addresses (e.g., in the memory 129 of the host system, or in the memory device attached by the memory sub-system 110 over the connection 103 to the host system 120).

The connection 103 between the host system 120 and the memory sub-system 110 can support a cache coherent memory access protocol. Cache coherence ensures that: changes to a copy of the data corresponding to a memory address are propagated to other copies of the data corresponding to the memory address; and load/store accesses to a same memory address are seen by processing devices (e.g., 127) in a same order.

The operating system 135 can include routines of instructions programmed to process storage access requests from applications.

In some implementations, the host system 120 configures a portion of its memory (e.g., 129) to function as queues 133 for storage access messages. Such storage access messages can include read commands, write commands, erase commands, etc. A storage access command (e.g., read or write) can specify a logical block address for a data block in a storage device (e.g., attached by the memory sub-system 110 to the host system 120 over the connection 103). The storage device can retrieve the messages from the queues 133, execute the commands, and provide results in the queues 133 for further processing by the host system 120 (e.g., using routines in the operating system 135).

Typically, a data block addressed by a storage access command (e.g., read or write) has a size that is much bigger than a data unit accessible via a memory access instruction (e.g., load or store). Thus, storage access commands can be convenient for batch processing a large amount of data (e.g., data in a file managed by a file system) at the same time and in the same manner, with the help of the routines in the operating system 135. The memory access instructions can be efficient for accessing small pieces of data randomly without the overhead of routines in the operating system 135.

The memory sub-system 110 has an interconnect 111 connecting the host interface 113, a controller 115, and memory resources, such as memory devices 107, . . . , 109.

The controller 115 of the memory sub-system 110 can control the operations of the memory sub-system 110. For example, the operations of the memory sub-system 110 can be responsive to the storage access messages in the queues 133, or responsive to memory access requests from the cache 123.

In some implementations, each of the memory devices (e.g., 107, . . . , 109) includes one or more integrated circuit devices, each enclosed in a separate integrated circuit package. In other implementations, each of the memory devices (e.g., 107, . . . , 109) is configured on an integrated circuit die; and the memory devices (e.g., 107, . . . , 109) can be configured in a same integrated circuit device enclosed within a same integrated circuit package. In further implementations, the memory sub-system 110 is implemented as an integrated circuit device having an integrated circuit package enclosing the memory devices 107, . . . , 109, the controller 115, and the host interface 113.

For example, a memory device 107 of the memory sub-system 110 can have volatile random access memory 138 that is faster than the non-volatile memory 139 of a memory device 109 of the memory sub-system 110. Thus, the non-volatile memory 139 can be used to provide the storage capacity of the memory sub-system 110 to retain data. At least a portion of the storage capacity can be used to provide storage services to the host system 120. Optionally, a portion of the volatile random access memory 138 can be used to provide cache-coherent memory services to the host system 120. The remaining portion of the volatile random access memory 138 can be used to provide buffer services to the controller 115 in processing the storage access messages in the queues 133 and in performing other operations (e.g., wear leveling, garbage collection, error detection and correction, encryption).

When the volatile random address memory 138 is used to buffer data received from the host system 120 before saving into the non-volatile memory 139, the data in the volatile random address memory 138 can be lost when the power to the memory device 107 is interrupted. To prevent data loss, the memory sub-system 110 can have a backup power source 105 that can be sufficient to operate the memory sub-system 110 for a period of time to allow the controller 115 to commit the buffered data from the volatile random access memory 138 into the non-volatile memory 139 in the event of disruption of an external power supply to the memory sub-system 110.

Optionally, the fast memory 138 can be implemented via non-volatile memory (e.g., cross-point memory); and the backup power source 105 can be eliminated. Alternatively, a combination of fast non-volatile memory and fast volatile memory can be configured in the memory sub-system 110 for memory services and buffer services.

The host system 120 can send a memory attachment capability query over the connection 103 to the memory sub-system 110. In response, the memory sub-system 110 can provide a response identifying: whether the memory sub-system 110 can provide cache-coherent memory services over the connection 103, what is the amount of memory that is attachable to provide the memory services over the connection 103, how much of the memory available for the memory services to the host system 120 is considered non-volatile (e.g., implemented via non-volatile memory, or backed with a backup power source 105), what is the access time of the memory that can be allocated to the memory services to the host system 120, etc.

The host system 120 can send a request over the connection 103 to the memory sub-system 110 to configure the memory services provided by the memory sub-system 110 to the host system 120. In the request, the host system 120 can specify: whether the memory sub-system 110 is to provide cache-coherent memory services over the connection 103, what is the amount of memory that is provided as the memory services over the connection 103, how much of the memory provided over the connection 103 is considered non-volatile (e.g., implemented via non-volatile memory, or backed with a backup power source 105), what is the access time of the memory is provided as the memory services to the host system 120, etc. In response, the memory sub-system 110 can partition its resources (e.g., memory devices 107, . . . , 109) and provide the requested memory services over the connection 103.

When a portion of the memory 138 is configured to provide memory services over the connection 103, the host system 120 can access a cached portion 132 of the memory 138 via load instructions and store instructions and the cache 123. The non-volatile memory 139 can be accessed via read commands and write commands transmitted via the queues 133 configured in the memory 129 of the host system 120.

Using the memory services of the memory sub-system 110 provided over the connection 103, the host system 120 can accumulate, in the memory of the subsystem (e.g., in a portion of the volatile random access memory 138), data identifying changes in a database. When the size of the accumulated change data is above a threshold, a change manager 101 can pack the change data into one or more blocks of data for one or more write commands addressing one or more logical block addresses. The change manager 101 can be implemented in the host system 120, or in the memory sub-system 110, or partially in the host system 120 and partially in the memory sub-system 110. The change manager 101 in the memory sub-system 110 can be implemented at least in part via instructions (e.g., firmware) executed by the processing device 117 of the controller 115 of the memory sub-system 110, or via logic circuit, or both.

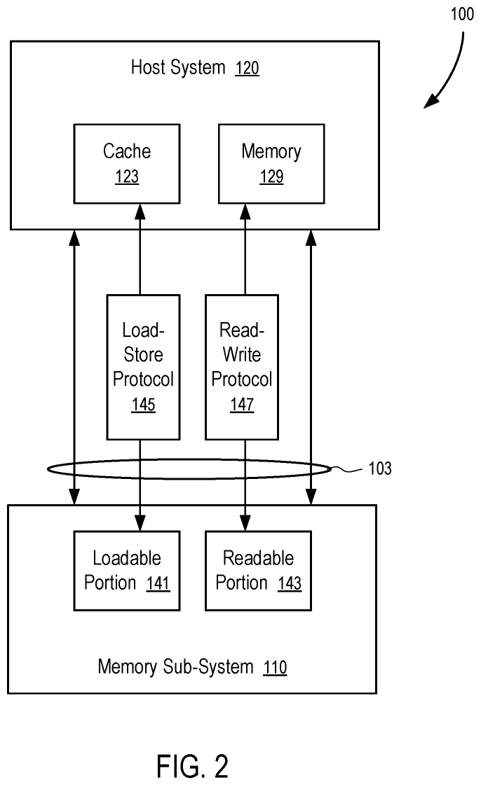

FIG. 2 shows a memory sub-system configured to offer both memory services and storage services to a host system over a physical connection according to one embodiment. For example, the memory sub-system 110 and the host system 120 of FIG. 2 can be implemented in a way as the computing system 100 of FIG. 1.

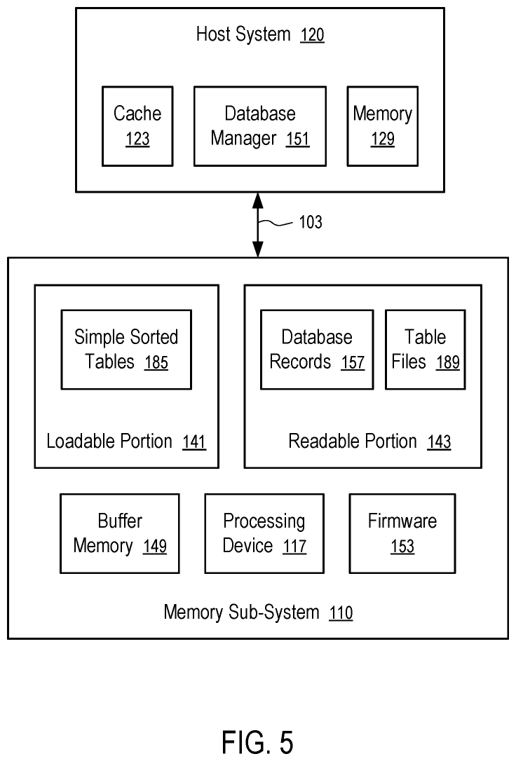

In FIG. 2, the memory resources (e.g., memory devices 107, . . . , 109) of the memory sub-system 110 are partitioned into a loadable portion 141 and a readable portion 143 (and an optional portion for buffer memory 149 in some cases, as in FIG. 5). A physical connection 103 between the host system 120 and the memory sub-system 110 can support a protocol 145 for load instructions and store instructions to access memory services provided in the loadable portion 141. For example, the load instructions and store instructions can be executed via the cache 123. The connection 103 can further support a protocol 147 for read commands and write commands to access storage services provided in the readable portion 143. For example, the read commands and write commands can be provide via the queues 133 configured in the memory 129 of the host system 120. For example, a physical connection 103 supporting a computer express link can be used to connect the host system 120 and the memory sub-system 110.

FIG. 2 illustrates an example of a same physical connection 103 (e.g., computer express link connection) configured to facilitate both memory access communications according to a protocol 145, and storage access communications according to another protocol 147. In general, separate physical connections can be used to provide the host system 120 with memory access according to a protocol 145 for memory access, and storage access according to another protocol 147 for storage access.

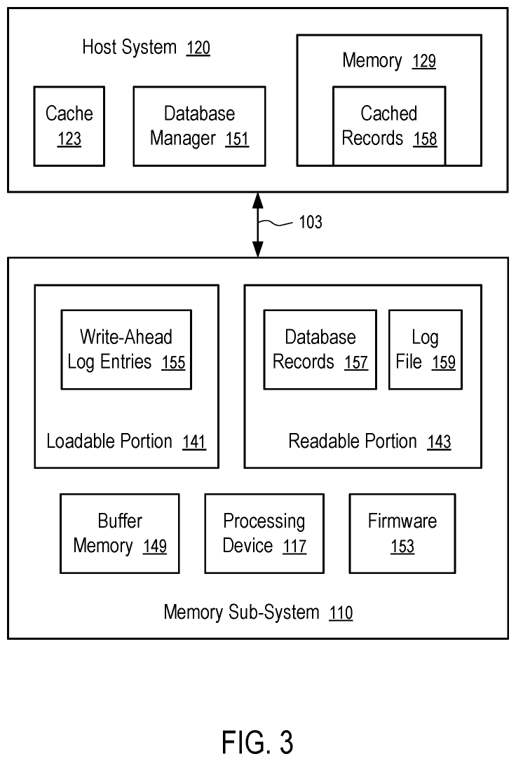

FIG. 3 illustrates the use of memory services provided by a memory sub-system to track write-ahead log entries for database records stored in the memory sub-system according to one embodiment. For example, the technique of FIG. 3 can be implemented in the computing systems 100 of FIG. 1 and FIG. 2.

In FIG. 3, a host system 120 can have a database manager 151 configured to perform database operations. The database manager 151 can use the readable portion 143 of the memory sub-system 110 to maintain a persistent copy of database records 157. For improved database performance, the database manager 151 can use its memory 129 to store cached records 158 that are in active used.

Before making changes to the records (e.g., 157, 158), the database manager 151 can save a persistent copy of data identifying the changes. For example, write-ahead log entries 155 can be used to identify changes to be made to the records (e.g., 157, 158). Thus, in the event of a crash, the recorded changes can be used to perform recovery operations. Further, the recorded changes allow rolling back the changes when requested or desirable.

A typical write-ahead log entry 155 does not have a predetermined, fixed size; and its size can be smaller than a predetermined block size of data addressable via logical block addresses. It is inefficient to use a write command to write, into the readable portion 143 (e.g., in a log file 159), a block of data of the size that is significantly larger than the size of the write-ahead log entry 155. Further, writing to a storage system is typically implemented through a storage stack involving a file system, a basic input/output system (BIOS) driver, a low level driver, all possible intermediate mappers and drivers. Thus, writing to a storage system can be extremely resource consuming and slow.

The database manager 151 can store write-ahead log entries 155 in the loadable portion 141 of the memory sub-system 110 for persistency and for accumulation.

For example, the database manager 151 can generate a write-ahead log entry 155 in the memory 129 of the host system 120 and then move the entry 155 from the host memory 129 to the loadable portion 141 in the memory sub-system 110 for persistence, instead of using a write command to write the write-ahead log entry 155 into the log file 159 in the readable portion 143. After the write-ahead log entry 155 is in the loadable portion 141 for persistence, the database manager 151 can make the changes to the cached records 158, as identified by the write-ahead log entry 155.

After the cached records 158 are stored into the readable portion 143 of the memory sub-system 110 for persistence, persistence storage of the write-ahead log entries 155 to identify changes may not be required. Thus, the write-ahead log entries 155 can be deleted without being written into a log file 159 in some instances. The memory space in the loadable portion 141 freed from the deletion of the write-ahead log entries 155 can be used to store further write-ahead log entries 155.

In some instances, there are more write-ahead log entries 155 to be preserved than what can be stored in the loadable portion 141. Thus, at least a portion of the write-ahead log entries 155 can be written from the loadable portion 141 into the log file 159 in the readable portion 143. After the write-ahead log entries 155 are written into the log file 159, the corresponding write-ahead log entries 155 in the loadable portion 141 can be erased. By grouping write-ahead log entries 155 for writing into the log file 159 in data blocks, the efficiency of the computing system in implementing the persistence of the write-ahead log entries 155 is improved.

In some implementations, the memory sub-system 110 can write write-ahead log entries 155 from the loadable portion 141 to the readable portion 143 in response to a request from the database manager 151, or automatically when the aggregated size of the write-ahead log entries 155 is above a threshold. Thus, it is unnecessary for the host system 120 to resend data of the write-ahead log entries 155 with write commands for writing the write-ahead log entries 155 into the log file 159.

In some implementations, the change manager 101 of the host system 120 and the change manager 101 of the memory sub-system 110 (e.g., implemented via the firmware 153) communicate with each other to save the write-ahead log entries 155 from the loadable portion 141 into the readable portion 143, and to retrieve the write-ahead log entries 155 from the log file 159 for use by the database manager 151.

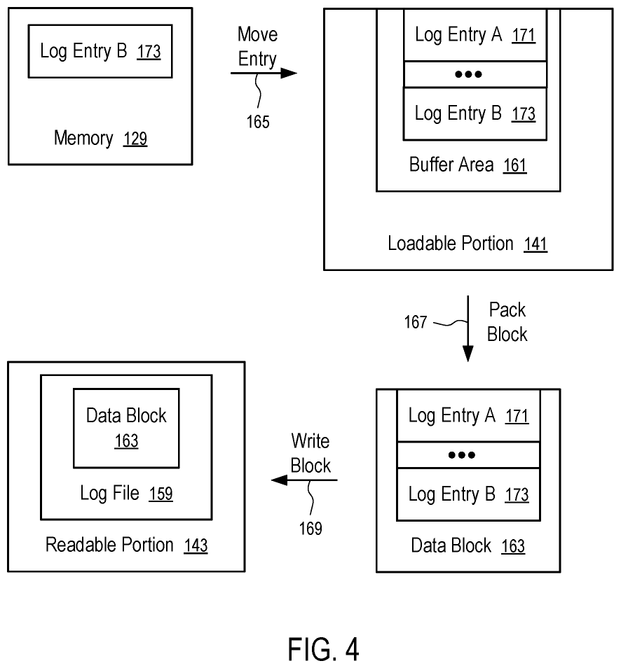

FIG. 4 shows the processing of log entries according to one embodiment. For example, the processing of log entries of FIG. 4 can be implemented in the computing systems 100 of FIG. 1 and FIG. 2 using the technique of FIG. 3.

In FIG. 4, a database manager 151 configured in a host system 120 can generate a log entry (e.g., 173) in the host memory 129 to identify a change to a database record (e.g., 157 or 158). Prior to making the change to the database record (e.g., 157 or 158), a change manager 101 can make persistence storage of the log entry 173. The change manager 101 can be implemented as part of the database manager 151, part of the operating system 135, part of a device driver of the memory sub-system 110, or a separate component. For example, the host memory 129 can be volatile. Thus, the change manager 101 can move 165 the entry (e.g., 173) from the host memory 129 into a buffer area 161 allocated in the loadable portion 141 of the memory sub-system 110 for the persistence storage of the log entry 173. Optionally, the database manager 151 can generate the log entry 173 directly in the buffer area 161.

Since the buffer area 161 is a non-volatile portion of a memory device attached by the memory sub-system 110 to the host system 120, the entries 171, . . . , 173 in the buffer area 161 can be considered stored persistently in the memory sub-system 110. For example, the entries 171, . . . , 173 in the buffer area 161 can be preserved even when an unexpected power supply interruption occurs to the memory sub-system 110.

After a number of log entries 171, . . . , 173 have accumulated in the buffer area 161, the change manager 101 can pack 167 at least some of the log entries in the loadable portion 141 into a data block 163 and write 169 the data block 163 into a log file 159 in the readable portion 143. Optionally, the change manager 101 can pack 167 the data block 163 in place within the buffer area 161 such that the data block 163 can be identified via a range of memory addresses.

In some implementations, the change manager 101 is partially implemented in the memory sub-system 110 to write the data block 163 directly from the buffer area 161 into the log file 159 without the host system 120 generating the data block 163 in the host memory 129. Since the log entries 171, . . . , 173 are already in the memory sub-system 110, the host system 120 does not have to re-transmit the data of the log entries 171, . . . , 173 over the connection 103 to write the data block 163.

In some implementations, the change manager 101 implemented in the host system 120 is configured to generate a write command in the queues 133 to request the memory sub-system 110 to write the data block 163, as in a range of memory addresses in the buffer area 161, at a location represented by a logical block address in the log file 159 in the readable portion 143. Since the log entries 171, . . . , 173 are already in the memory sub-system 110, the host system 120 does not have to re-transmit the data of the log entries 171, . . . , 173 over the connection 103 to write the data block 163.

In some implementations where the memory sub-system 110 has insufficient support to write the data block 163 in the log file 159 based on the log entries 171, . . . , 173 in the buffer area 161 (e.g., packed in place in the buffer area 161), the change manager 101 in the host system 120 can be configured to pack 167 the log entries 171, . . . , 173 in the host memory 129 and generate a write command to write the data block 163 into the log file 159 via the queues 133 configured in the system memory 129. For example, the log entries 171, . . . , 173 in FIG. 4 can be write-ahead log entries 155, or records of changes configured in other formats.

In some implementations, database changes are tracked using simple sorted tables (SST). The tables are organized at levels based on how recently they have been created. Each table can include key-value pairs to identify changes in a database. Tables can be stored in a storage device in ascending order of recency levels. For improved performance, the newly created tables can be kept in memory. The change manager 101 can be configured to place the newly created tables in the loadable portion 141 of the memory sub-system 110 for persistence, in a way similar to the persistence storage of the write-ahead log entries 155, as further discussed in connection with FIG. 5.

FIG. 5 illustrates the use of memory services provided by a memory sub-system to store a stored string table for changes in database records stored in the memory sub-system according to one embodiment. For example, the technique of FIG. 5 can be implemented in the computing systems 100 of FIG. 1 and FIG. 2.

In FIG. 5, a host system 120 can have a database manager 151 configured to perform database operations, as in FIG. 3. The database manager 151 can use the readable portion 143 of the memory sub-system 110 to maintain a persistent copy of database records 157. For improved database performance, the database manager 151 can use its memory 129 to store cached records 158 that are in active used.

Before making changes to the records (e.g., 157, 158), the database manager 151 can save a persistent copy of data identifying the changes. For example, simple sorted tables 185 can be used to identify changes to be made to the records (e.g., 157, 158). Thus, in the event of a crash, the recorded changes can be used to perform recovery operations. Further, the recorded changes allow rolling back the changes when requested or desirable.

For improved efficiency in operations related to the simple sorted tables 185, the most recent tables 185 can be maintained in memory. For example, the loadable portion 141 can be used to store the most recent tables 185 before the tables 185 are written into table files 189.

Optionally, the change manager 101 can move the most recent tables 185 between the host memory 129 and the loadable portion 141 in the memory sub-system 110.

Since the loadable portion 141 is non-volatile (e.g., implemented via fast non-volatile memory, or volatile memory backed with a backup power source 105), the simple sorted tables 185 in the loadable portion can be preserved when unexpected power outage occurs.

In some implementations, the memory sub-system 110 can write simple sorted tables 185 from the loadable portion 141 to the readable portion 143 in response to a request from the host system 120, or automatically when the aggregated size of the simple sorted tables 185 is above a threshold. Thus, it is unnecessary for the host system 120 to resend data of the data of the simple sorted tables 185 with write commands for writing the tables 185 into the table files 189 in the readable portion 143.

In some implementations, the change manager 101 in the host system 120 and the change manager 101 in the memory sub-system 110 communicate with each other to save the simple sorted tables 185 from the loadable portion 141 into the readable portion 143, and to retrieve the simple sorted tables 185 from the table files 189 for use by the database manager 151.

In some implementations where the memory sub-system 110 has insufficient support to write the table files 189 using the simple sorted tables 185 stored in the loadable portion 141, the change manager 101 in the host system 120 can be configured to pack the data of the simple sorted tables 185 into data blocks in the host memory 129 and generate write commands to write the data blocks into the table files 189 via the queues 133 configured in the system memory 129.

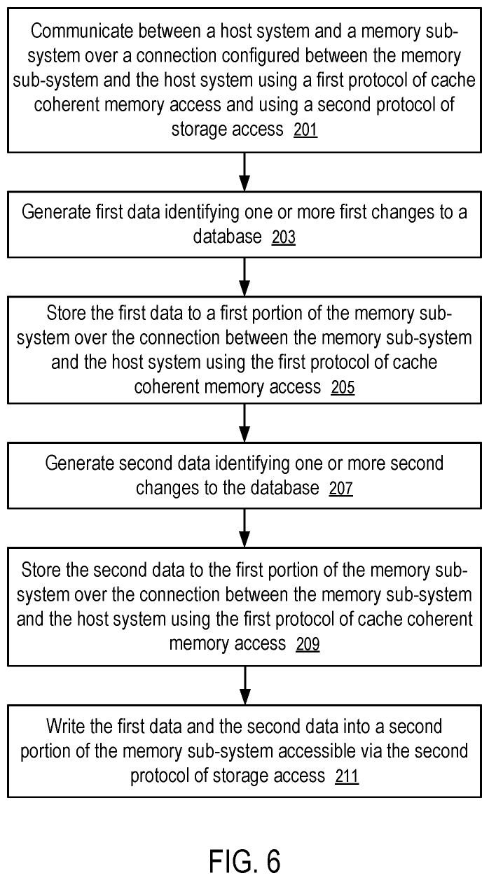

FIG. 6 shows a method to track changes to database records according to one embodiment. For example, the method of FIG. 6 can be implemented in computing systems 100 of FIG. 1 and FIG. 2 with the techniques of FIG. 3, FIG. 4, and FIG. 5 to use the memory services of a memory sub-system 110 to persistently store data identifying changes to a database.

For example, a memory sub-system 110 (e.g., a solid-state drive) and a host system can be connected via at least one physical connection 103. The memory sub-system 110 can optically carve out a portion (e.g., loadable portion 141) of its fast memory (e.g., 138) as a memory device attached to the host system 120. The memory sub-system 110 can reserve a portion (e.g., buffer memory 149) of its fast memory (e.g., 138) as an internal memory for its processing device(s) (e.g., 117). The memory sub-system 110 can have a portion (e.g., readable portion 143) of its memory resources (e.g., non-volatile memory 139) as a storage device attached to the host system 120.

The memory sub-system 110 can have a backup power source 105 designed to guarantee that data stored in at least a portion of volatile random access memory 138 is saved in a non-volatile memory 139 when the power supply to the memory sub-system 110 is disrupted. Thus, such a portion of the volatile random access memory 138 can be considered non-volatile in the memory services to the host system 120.

A database manager 151 running in the host system 120 can write, using a storage protocol (e.g., 147) through a connection 103 to the host interface 113 of the memory sub-system 110, records of a database into a storage portion (e.g., 143) of the memory sub-system 110. The database manager 151 can include a change manager 101 configured to generate data identifying changes to the database, such as write-ahead log entries 155, simple sorted tables 185, etc. The change manager 101 can store, using a cache coherent memory access protocol (e.g., 145) through the connection 103 to the host interface 113 of the memory sub-system 110, the data into a memory portion (e.g., 141) of the memory sub-system 110 prior to making the changes to the database. Since the memory portion (e.g., 141) is implemented via a non-volatile memory, or a volatile memory 138 with a backup power source 105, storage of the data in the memory portion (e.g., 141) is persistent. After the data is stored persistently in the memory portion (e.g., 141) of the memory sub-system 110, the database manager 151 can make the changes to the database.

At block 201, the host system 120 and the memory sub-system 110 communicate between with each other over a connection 103 configured between the memory sub-system 110 and the host system 120 using a first protocol (e.g., 145) of cache coherent memory access and using a second protocol (e.g., 147) of storage access.

At block 203, the host system 120 generates first data identifying one or more first changes to a database.

For example, the first data identifying changes to the database can be in the form of write-ahead log entries 155 or simple sorted tables 185.

At block 205, the host system 120 stores the first data to a first portion (e.g., 141) of the memory sub-system 110 over the connection 103 between the memory sub-system 110 and the host system 120 using the first protocol (e.g., 145) of cache coherent memory access.

At block 207, the host system 120 generates second data identifying one or more second changes to the database.

For example, the second data identifying changes to the database can be in the form of further write-ahead log entries 155 or simple sorted tables 185.

At block 209, the host system 120 stores the second data to the first portion (e.g., 141) of the memory sub-system 110 over the connection between the memory sub-system 110 and the host system 120 using the first protocol of cache coherent memory access.

The size of the first data and the size of the second data can be small; and writing the first data and writing the second data separately using the second protocol (e.g., 147) of storage access to a file into the memory sub-system 110 can be inefficient. After change data (e.g., the first data and the second data) has accumulated in the first portion (e.g., 141) of the memory sub-system 110, the change data can be written into a file 189 (e.g., 159 or 189).

For example, the first data and the second data can be stored into the first portion (e.g., 141) of the memory sub-system via store instructions executed in host system 120 identifying memory addresses in the first portion (e.g., 141) of the memory sub-system 110.

At block 211, the first data and the second data are written into a second portion (e.g., 143) of the memory sub-system 110 accessible via the second protocol (e.g., 147) of storage access.

For example, the connection 103 between the host system 120 and the memory sub-system 110 can be a computer express link (CXL) connection.

For example, the first data and the second data can be written into the second portion (e.g., 143) of the memory sub-system 110 via a write command into a file (e.g., 159, 189) hosted in the second portion (e.g., 143) of the memory sub-system 110. For example, the write command is configured to identify data to be written at a logical block address in the second portion (e.g., 143) of the memory sub-system 110 by a reference to a data block 163 in the first portion (e.g., 141) of the memory sub-system 110. For example, the reference can be based on a range of memory addresses in the first portion (e.g., 141). The writing of the first data and the second data into the second portion (e.g., 143) of the memory sub-system 110 can be in response to an aggregated size of change data stored in the first portion (e.g., 141) of the memory sub-system 110 exceeding a threshold. After the first data and the second data are stored in the first portion (e.g., 141) of the memory sub-system 110, the writing of the first data and the second data into the second portion (e.g., 143) of the memory sub-system includes no further communications of the first data and the second data over the computer express link (CXL) connection from the host system 120 to the memory sub-system 110.

For example, the change manager 101 and the database manager 151 can perform write-ahead logging to generate the change data (e.g., write-ahead log entries 155) and store persistently the change data in the loadable portion 141 of the memory sub-system 110, before the corresponding changes are made to the database.

For example, the change manager 101 and the database manager 151 can create simple sorted tables 185 in the memory portion (e.g., 141) of the memory sub-system 110 and use the simple sorted tables 185 in the memory portion (e.g., 141) to track changes to the database.

The change manager 101 can store the change data (e.g., write-ahead log entries 155, simple sorted tables 185) from the memory portion (e.g., 141) of the memory sub-system 110 to the storage portion (e.g., 143) of the memory sub-system 110.

In some implementations, the change manager 101 is implemented at least in part in the memory sub-system 110 (e.g., via the firmware 153 of the memory sub-system 110). The change manager 101 can write the change data from the memory portion (e.g., 141) to the storage portion (e.g., 143) without separately receiving the change data after the change data has been stored to the memory portion (e.g., 141).

In some implementations, the change manager 101 in the memory sub-system 110 can automatically write at least a portion of the change data in the memory portion (e.g., 141) to a file (e.g., 159 or 189) in the storage portion (e.g., 143) after the size of the change data grows to reach or exceed a predetermined threshold. Alternatively, a write command is sent by the change manager 101 in the host system 120 to the memory sub-system 110 using the second protocol (e.g., 147) of storage access; and in response, the change manager 101 in the memory sub-system 110 can write a block 163 of change data from the memory portion (e.g., 141) to a logical block address in the storage portion (e.g., 143).

In some implementations, the change manager 101 in the memory sub-system 110 and the change manager 101 in the host system 120 can communicate with each other via the connection 103 to move change data between the memory portion (e.g., 141) and the storage portion (e.g., 143). For example, in response to a request from the host system 120, the change manager 101 in the memory sub-system 110 can read change data from a file (e.g., 159 or 189) to the memory portion (e.g., 141) for access by the host system 120 using load instructions. For example, in response to a request from the host system 120, the change manager 101 in the memory sub-system 110 can write change data into a file (e.g., 159 or 189) for the memory portion (e.g., 141) such that the host system 120 can subsequently access the change data in the file (e.g., 159 or 189) using read commands.

Change data in the memory portion (e.g., 141) can be addressable by the host system 120 using memory addresses configured in load instructions and store instructions; and change data in the storage portion (e.g., 143) can be addressable by the host system 120 using logical block addresses configured in read commands and write commands.

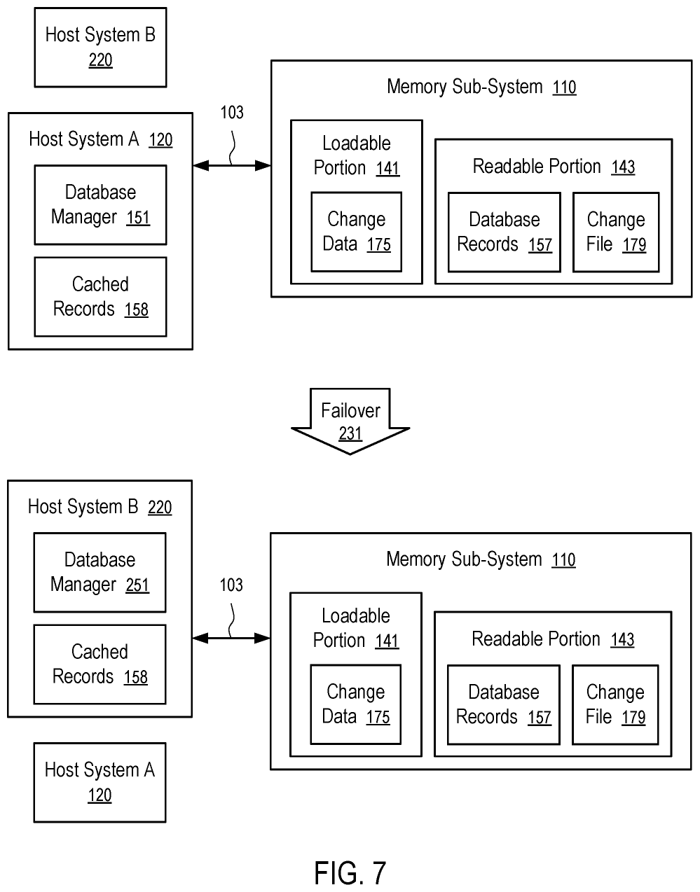

FIG. 7 shows an example of host system failover 231 based on memory services provided by a memory sub-system 110 according to one embodiment. For example, the failover 231 can be implemented for the computing systems 100 of FIG. 1 and FIG. 2 with the techniques of FIG. 3, FIG. 4, FIG. 5, and FIG. 6 of using the memory services of a memory sub-system 110 to persistently store data identifying changes to a database.

In FIG. 7, the memory sub-system 110 is connected via a connection 103 to a host system 120 for normal operations, as in FIG. 1 to FIG. 6. During the normal operations, another host system 220 can be disconnected from the memory sub-system 110 (e.g., via a switch). Alternatively, the memory sub-system 110 can have two ports for connections to the host systems 120 and 220 respectively. During the normal operation, the host system 120 uses the readable portion 143 to manage and operate on the database records 157 over the connection 103; and the host system 220 can be inactive in using the memory sub-system 110 through its connection to the memory sub-system 110 (or active in using the memory sub-system 110 but for a different task, such as managing and operating a different database). Thus, the failover 231 does not require physically rewiring the memory sub-system 110 and the host systems 120 and 220.

For example, the host system 120 can be configured to store, in the loadable portion 141 of the memory sub-system 110, in-memory change data 175 indicative of changes to the database records 157 stored in the readable portion 143, in addition to the changes identified in the change file 179.

For example, the change data 175 can include write-ahead log entries 155 of FIG. 3; and the change file 179 can include the log file 159.

For example, the change data 175 can include simple sorted tables 185 of FIG. 5; and the change file 179 can include table files 189.

The database records 157, the change file 179, and the change data 175 as a whole identify a valid state of a database operated by the database manager 151 running in the host system 120. When the host system 120 fails, the memory sub-system 110 can be reconnected to a replacement host system 220 in an operation of failover 231. A database manager 251 running in the replacement host system 220 can be assigned to perform the database operations previously assigned to the replaced host system 120. Since the memory sub-system 110 preserves the most recent state of the database via the database records 157, the change file 179, and the in-memory change data 175, the replacement host system 220 can continue the operations previously assigned to the replaced host system 120 with reduced or minimum loss.

Optionally, a remote direct memory access (RDMA) network can be connected between the host systems 120 and 220 during the normal operations of the host system 120 that is being replaced during the failover 231. The memory 129 of the replaced host system 120 can have in-memory content, such as cached records 158. The in-memory content can be replicated via the remote direct memory access (RDMA) network to the replacement host system 220 during the normal operation of the replaced host system 120. Thus, when the replaced host system 120 fails, the replacement host system 220 can have a copy of the in-memory content of the replaced host system 120 and thus ready to continue operations using the memory sub-system 110. However, configuring the operations of the remote direct memory access (RDMA) network for memory replication can be an expensive option.

Since the memory sub-system 110 preserves the state of the database as being operated by the replaced host system 110, the replacement system 220 can reconstruct the cached records 158 from the data in the memory sub-system 110 to eliminate the need to replicate at least some of the in-memory content of the replaced host system 120, such as the cached records 158.

Optionally, some of the in-memory content of the host system 120, such as cached records 158, can be stored by the host system 120 into the loadable portion 141 via memory copying. Thus, the replacement host system 120 can obtain the in-memory content via copying from the loadable portion 141 once the memory sub-system 110 is re-connected to the replacement host system 220.

Optionally, the host system 120 can be configured to use the memory space provided by the loadable portion 141 (and access via the use of cache 123 and cache coherent memory access protocol 145 for improved performance), instead of its memory 129, to directly generate the change data 175 (and optionally, other in-memory content). Thus, the copying content between the memory 129 of the host system 120 and the loadable portion 141 can be reduced or minimized.

When the memory sub-system 110 is reconnected to the replacement host system 220, it is not necessary to copy the corresponding content from the loadable portion 141 back to the memory of the replacement host system 220, since the replacement host system 220 can use the memory space provided by the loadable portion 141 via its cache 123 and the cache coherent memory access protocol (e.g., 145) over the connection 103 (e.g., computer express link connection).

In some implementations, both the host systems 120 and 220 are active in performing database operations. Some or all of the database operations assigned to a host system 120 can be transferred to another host system 220 (e.g., for failover 231, load balancing, maintenance operations, etc.).

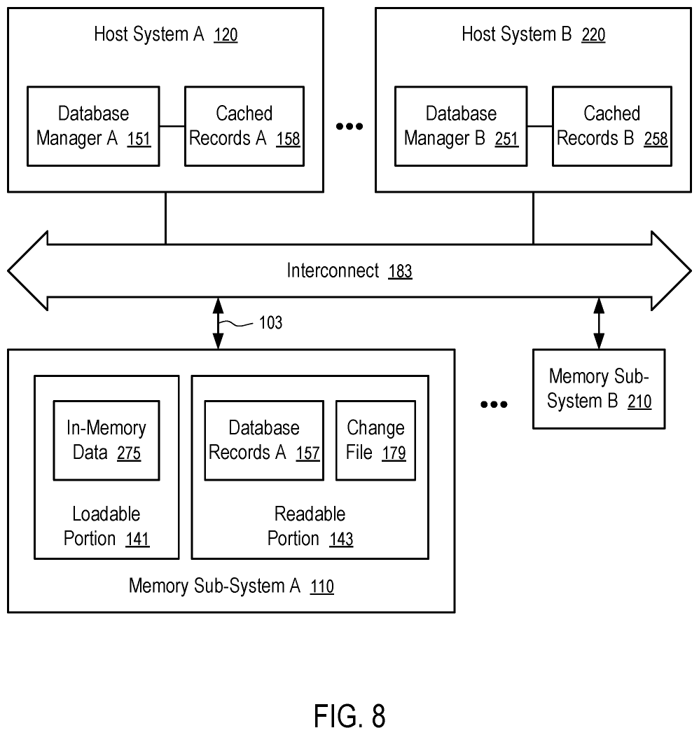

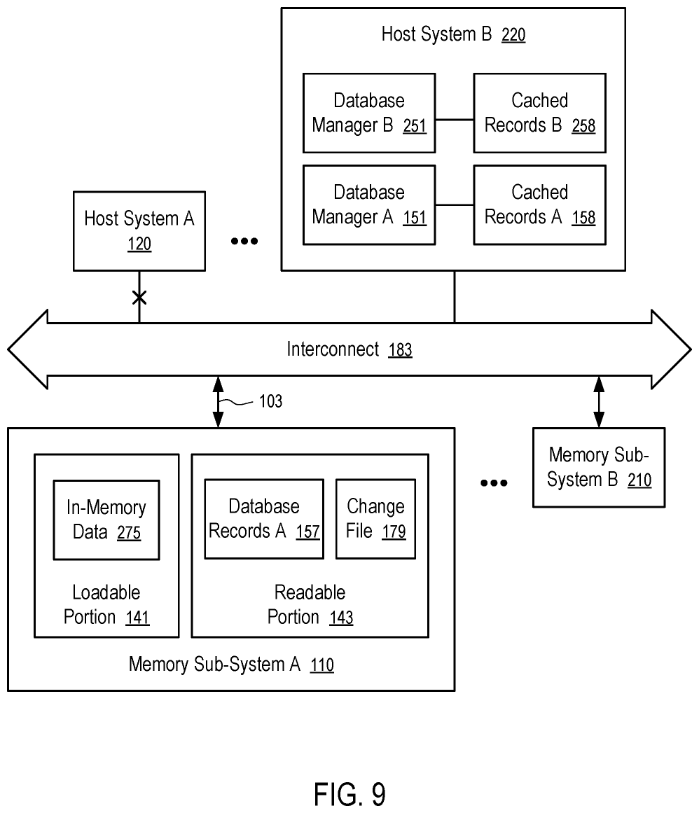

FIG. 8 and FIG. 9 illustrate an active host system taking over the database operations of another host system using in-memory change data stored in a memory sub-system according to one embodiment. For example, the technique illustrated in FIG. 8 and FIG. 9 can be implemented for the computing systems 100 of FIG. 1 and FIG. 2 with the techniques of FIG. 3, FIG. 4, FIG. 5, and FIG. 6 of using the memory services of a memory sub-system 110 to persistently store data identifying changes to a database.

In FIG. 8 and FIG. 9, host systems 120, . . . , 220 are connected to memory sub-system 110, . . . , 210 via interconnect 183. For example, the interconnect 183 can include a switch to connect a memory sub-system 110 to a host system 120; and in some instances, multiple memory sub-systems 210 can be connected to a host system (e.g., 120, or 220).

For example, the host system 120 can run a database manager 151 to operate on database records 157 that are configured for persistent storage in the readable portion 143 of the memory sub-system 110. Changes made in the host system 120 to database records (e.g., 157, 158) managed by the database manager 151 are recorded in the change file 179 stored in the readable portion 143 of the memory sub-system 110 and in the loadable portion 141 of the memory sub-system 110. The in-memory data 275 stored in the loadable portion 141 of the memory sub-system 110 identifies the most current state of the database records (e.g., 157, 158) managed by the database manager 151.

Similarly, the host system 220 can run a database manager 251 to operation on database records hosted on another memory sub-system (e.g., 210). The database manager 251 running in the host system 220 can have its cached records 258. Optionally, a portion of the database operations of the database manager 251 can be performed for database records hosted on the memory sub-system 110 (e.g., a set of database records different from the records 157 operated by the database manager 151 running in the host system 120).

In FIG. 9, when the host system 120 becomes inaccessible (e.g., when the host system 120 fails or is being disconnected or turned off), the content stored in its memory 129 (e.g., cached records 158) is inaccessible and can be considered lost. In response to detecting that the host system 120 becomes inaccessible, the computing system can assign another host system 220 to manage the database records (e.g., 157) previously managed by the previous host system 120.

For example, in response to the host system 120 becomes inaccessible, the interconnect 183 of the computing system can be configured to re-connect the memory sub-system 110 to the active host system 220, instead of to the previous host system 120. The active host system 220 can start a database manager 151 to manage the database records 157 stored in the readable portion 143 of the memory sub-system 110. The memory sub-system 110 attaches the loadable portion 141 as a memory device to the active host system 220 over the connection 103, in a way similar to or same as the memory sub-system 110 attaching the loadable portion 141 as a memory device to the previous host system 220 over the connection 103. Thus, the in-memory data 275 becomes available to the database manager 151 running in the host system 220. Based on the in-memory data 275 in the loadable portion 141 and the change file 179, the database manage 151 can reconstruct the cached records 158.

Optionally, a typical host system (e.g., 120, 220) in the computing system of FIG. 8 and FIG. 9 can be configured to run multiple instances of database managers (e.g., 151 and 251), in a way similar to the host system 220 running database managers 151 and 251 to manage database records hosted on multiple memory sub-systems (e.g., 110 and 210). The computing system can perform load balancing by moving the execution of some instances of database managers among the host systems 120, . . . , 220.

For example, when the host system 120 in FIG. 9 is reconnected to the interconnect 183 for operations, the computation tasks of running the database manager 151 in the host system 220 can be re-assigned to the host system 120, as in FIG. 8 to balance the loads applied to the host systems 120, . . . , 220. For example, the memory device provided by the loadable portion 141 of the memory sub-system 110 can be disconnected from the host system 220 and connected to the host system 120; similarly, the storage device provided by the readable portion 143 of the memory sub-system 110 can be disconnected from the host system 220 and connected to the host system 120; and subsequently, the host system 120 can reconstruct the cached records 158 from the in-memory data 275 in the loadable portion 141, and the change file 179 and the database records 157 in the readable portion 143.

Optionally, the in-memory data 275 can include at least a portion of the cached records 158. Thus, the construction of the cached records 158 in the memory 129 of a host system (e.g., 220 or 120) can be performed via memory copying from the loadable portion 141 to the memory 129 of the host system (e.g., 220 or 120), without the need to send read commands to access the readable portion 143. In some implementations, the cached records 158 are configured to be located in the memory device provided by the loadable portion 141; and thus, it is not necessary to copy the cached records 158 from the loadable portion 141 to the memory 129 of the host system 120.

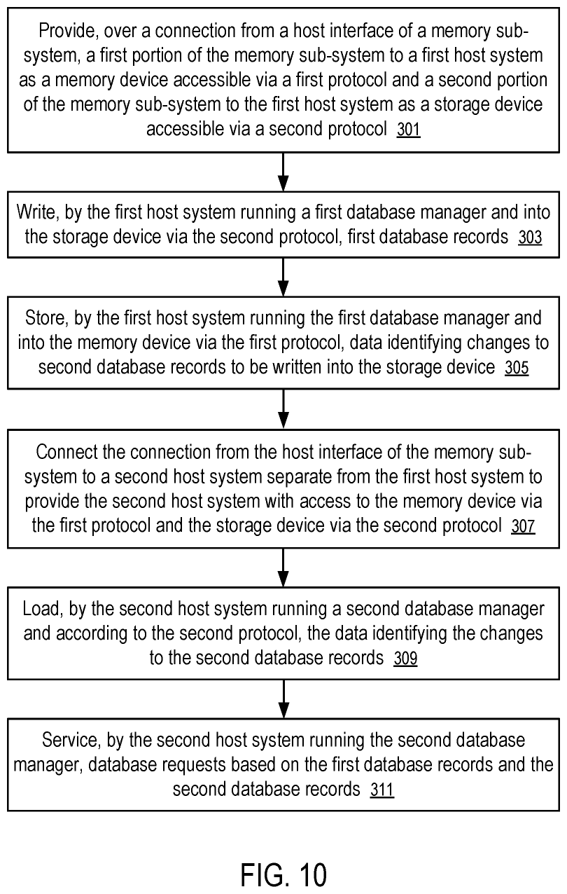

FIG. 10 shows a method to transfer database operations between host systems according to one embodiment. For example, the method of FIG. 10 can be implemented as in FIG. 7, or as in FIG. 8 and FIG. 9, with computing systems 100 of FIG. 1 and FIG. 2 with the techniques of FIG. 3, FIG. 4, FIG. 5, and FIG. 6 of using the memory services of a memory sub-system 110 to persistently store data identifying changes to a database.

At block 301, over a connection 103 from a host interface 113 of a memory sub-system 110, a first portion (e.g., 141) of the memory sub-system 110 is provided to a first host system 120 as a memory device accessible via a first protocol (e.g., 145); and a second portion (e.g., 143) of the memory sub-system 110 is provided to the first host system 120 as a storage device accessible via a second protocol (e.g., 147).

For example, the memory sub-system 110 can be a solid-state drive having a host interface 113 for a computer express link connection 103. The memory sub-system 110 can allocate a loadable portion 141 of its fast memory (e.g., 138) as a memory device for attachment to a host system (e.g., 120 or 220). The memory sub-system 110 can reserve a portion of its fast memory (e.g., 138) as a buffer memory 149 for its processing device(s) (e.g., 117). The memory sub-system 110 can allocate a readable portion 143 of its memory resources (e.g., non-volatile memory 139) as a storage device for attachment to a host system (e.g., 120 or 220).

The memory sub-system 110 can have a backup power source 105 designed to guarantee that data stored at least in the loadable portion 141 implemented using a volatile random access memory 138 is saved in a non-volatile memory 139 when the power supply to the memory sub-system 110 is disrupted. Thus, such a loadable portion 141 attached as a memory device to a host system (e.g., 120 or 220) can be considered non-volatile in the memory services to the host system (e.g., 120 or 220).

For example, the first protocol (e.g., 145) can be configured for cache coherent memory access via execution of load instructions and store instructions in a host system (e.g., 120 or 220); and the second protocol (e.g., 147) can be configured for storage access via read commands and write commands to be executed in the memory sub-system 110.

For example, the first protocol (e.g., 145) can be configured to identify access locations via memory addresses at a first data granularity (e.g., 32B, 64B or 128B) for load instructions and store instructions; and the second protocol (e.g., 147) is configured to identify access locations via logical block addresses at a second data granularity (e.g., 4 KB) for read commands and write commands.

At block 303, the first host system 110 running a first database manager 151 writes, into the storage device via the second protocol (e.g., 147), first database records 157.

For example, the database manager 151 running in the first host system 120 can write, using a storage protocol (e.g., 147) through the connection 103 to the host interface 113 of the memory sub-system 110, records 157 of a database into a storage portion (e.g., 143) of the memory sub-system 110. For improved performance, the database manager 151 can have cached records 158 in the memory 129 of the first host system 120. Some of the cached records 158 can be new or updated database records that have not yet been stored into the storage portion (e.g., 143) of the memory sub-system 110.

At block 305, the first host system 110 running the first database manager 151 stores, into the memory device via the first protocol (e.g., 145), data (e.g., 175 or 275) identifying changes to second database records 158 to be written into the storage device.

The database manager 151 can include a change manager 101 configured to generate data 175 identifying changes to the database, such as write-ahead log entries 155, simple sorted tables 185, etc. The change manager 101 can store, using a cache coherent memory access protocol (e.g., 145) through the connection 103 to the host interface 113 of the memory sub-system 110, the change data 175 into a memory portion (e.g., 141) of the memory sub-system 110 prior to making the changes to the database. Thus, the cached records 158 can be reconstructed using the change data 175.

In some instances, it is desirable to transfer the database operations of the first host system 120 to a second host system 120 for failover 231, for load balancing, etc. In some instances, the content in the memory 129 of the first host system 120 can become inaccessible or lost (e.g., when the first host system 120 fails).

At block 307, the connection 103 from the host interface 113 of the memory sub-system 110 is connected to a second host system 220 separate from the first host system 120 to provide the second host system 220 with access to the memory device via the first protocol (e.g., 145) and the storage device via the second protocol (e.g., 147).

For example, the memory sub-system 110 can attach the loadable portion 141 as a memory device to the second host system 220 in a same way as attaching the memory device to the first host system 220 before the transfer (e.g., before the first host system 220 fails). Similarly, the memory sub-system 110 can attach the readable portion 141 as a storage device to the second host system 220 in a same way as attaching the storage device to the first host system 220 before the transfer (e.g., before the first host system 220 fails). The second host system 220 can use the memory device and the storage device to start the operations of a second database manager (e.g., 251 in FIG. 7; 151 in FIG. 9) in a same way as the first database manager 151 using the memory device and the storage device attached by the memory sub-system 110 before the transfer.

Since some of the second database records 158 have not yet been stored into the storage portion (e.g., 143) of the memory sub-system 110 by the first host system 110, the storage device provided by the memory sub-system 110 contains no data representative of such second database records at a time of the failure of the first host system 120 and at the time of the memory sub-system 110 being reconnected to the second host system 220.

At block 309, the second host system 220 running a second database manager (e.g., 251 in FIG. 7; 151 in FIG. 9) loads, according to the second protocol (e.g., 147), the data (e.g., 175 or 275) identifying the changes to the second database records 158.

For example, using the data (e.g., 175 or 275) identifying the changes to the second database records 158, the second database manager (e.g., 251 in FIG. 7; 151 in FIG. 9) can reconstruct the second database records 158 that have been, or would be, generated in the memory of the first host system 120.

In some implementations, the first host system 120 stores, in the memory device represented by the loadable portion 141, not only the data identifies the changes to the second database records 158, but also the cached records 158 that have been generated or updated by the first database manager 151. For example, the first database manager 151 can generate the cached records 158 in its memory 129 and perform a memory copy of the cached records 158 from the memory 129 to the loadable portion 141. Alternatively, the first database manager 151 can be configured to use the loadable portion 141 as memory for the cached records 158 (instead of using its memory 129).

Thus, the second host system 220 can copy the second database records 158, previously generated or update by the first host system 120, from the loadable portion 141 to its memory, or directly use the second database records 158 as stored in the loadable portion 141.

At block 311, the second host system 220 running the second database manager (e.g., 251 in FIG. 7; 151 in FIG. 9) services database requests based on the first database records 157 and the second database records 158.

In general, a memory sub-system 110 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a portion of a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 120 that is coupled to one or more memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 120 can include a processor chipset (e.g., processing device 127) and a software stack executed by the processor chipset. The processor chipset can include one or more cores, one or more caches (e.g., 123), a memory controller (e.g., controller 125) (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface 113. Examples of a physical host interface include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface can be used to transmit data between the host system 120 and the memory sub-system 110. The host system 120 can further utilize an NVM express (NVMe) interface to access components (e.g., memory devices 109) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The processing device 127 of the host system 120 can be, for example, a microprocessor, a central processing unit (CPU), a processing core of a processor, an execution unit, etc. In some instances, the controller 125 can be referred to as a memory controller, a memory management unit, and/or an initiator. In one example, the controller 125 controls the communications over a bus coupled between the host system 120 and the memory sub-system 110. In general, the controller 125 can send commands or requests to the memory sub-system 110 for desired access to memory devices 109, 107. The controller 125 can further include interface circuitry to communicate with the memory sub-system 110. The interface circuitry can convert responses received from the memory sub-system 110 into information for the host system 120.

The controller 125 of the host system 120 can communicate with the controller 115 of the memory sub-system 110 to perform operations such as reading data, writing data, or erasing data at the memory devices 109, 107 and other such operations. In some instances, the controller 125 is integrated within the same package of the processing device 127. In other instances, the controller 125 is separate from the package of the processing device 127. The controller 125 and/or the processing device 127 can include hardware such as one or more integrated circuits (ICs) and/or discrete components, a buffer memory, a cache memory, or a combination thereof. The controller 125 and/or the processing device 127 can be a microcontroller, special purpose logic circuitry (e.g., a field programmable gate array (FPGA), an application specific integrated circuit (ASIC), etc.), or another suitable processor.

The memory devices 109, 107 can include any combination of the different types of non-volatile memory components and/or volatile memory components. The volatile memory devices (e.g., memory device 107) can be, but are not limited to, random-access memory (RAM), such as dynamic random-access memory (DRAM) and synchronous dynamic random-access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 109 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 109 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells of the memory devices 109 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 109 can be based on any other type of non-volatile memory, such as read-only memory (ROM), phase change memory (PCM), self-selecting memory, other chalcogenide based memories, ferroelectric transistor random-access memory (FeTRAM), ferroelectric random-access memory (FeRAM), magneto random-access memory (MRAM), spin transfer torque (STT)-MRAM, conductive bridging RAM (CBRAM), resistive random-access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 109 to perform operations such as reading data, writing data, or erasing data at the memory devices 109 and other such operations (e.g., in response to commands scheduled on a command bus by controller 125). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the controller 115, in another embodiment of the present disclosure, a memory sub-system 110 does not include a controller 115, and can instead rely upon external control (e.g., provided by an external host, or by a processor or controller separate from the memory sub-system).

In general, the controller 115 can receive commands or operations from the host system 120 and can convert the commands or operations into instructions or appropriate commands to achieve the desired access to the memory devices 109. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 109. The controller 115 can further include host interface circuitry to communicate with the host system 120 via the physical host interface. The host interface circuitry can convert the commands received from the host system into command instructions to access the memory devices 109 as well as convert responses associated with the memory devices 109 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the controller 115 and decode the address to access the memory devices 109.

In some embodiments, the memory devices 109 include local media controllers 137 that operate in conjunction with the memory sub-system controller 115 to execute operations on one or more memory cells of the memory devices 109. An external controller (e.g., memory sub-system controller 115) can externally manage the memory device 109 (e.g., perform media management operations on the memory device 109). In some embodiments, a memory device 109 is a managed memory device, which is a raw memory device combined with a local controller (e.g., local media controller 137) for media management within the same memory device package. An example of a managed memory device is a managed NAND (MNAND) device.

In one embodiment, an example machine of a computer system within which a set of instructions, for causing the machine to perform any one or more of the methodologies discussed herein, can be executed. In some embodiments, the computer system can correspond to a host system (e.g., the host system 120 of FIG. 1) that includes, is coupled to, or utilizes a memory sub-system (e.g., the memory sub-system 110 of FIG. 1) or can be used to perform the operations discussed above (e.g., to execute instructions to perform operations corresponding to operations described with reference to FIG. 1). In alternative embodiments, the machine can be connected (e.g., networked) to other machines in a LAN, an intranet, an extranet, and/or the internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, a network-attached storage facility, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system includes a processing device, a main memory (e.g., read-only memory (ROM), flash memory, dynamic random-access memory (DRAM) such as synchronous DRAM (SDRAM) or Rambus DRAM (RDRAM), static random-access memory (SRAM), etc.), and a data storage system, which communicate with each other via a bus (which can include multiple buses).

Processing device represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device can also be one or more special-purpose processing devices such as an application specific integrated circuit (ASIC), a field programmable gate array (FPGA), a digital signal processor (DSP), network processor, or the like. The processing device is configured to execute instructions for performing the operations and steps discussed herein. The computer system can further include a network interface device to communicate over the network.

The data storage system can include a machine-readable medium (also known as a computer-readable medium) on which is stored one or more sets of instructions or software embodying any one or more of the methodologies or functions described herein. The instructions can also reside, completely or at least partially, within the main memory and/or within the processing device during execution thereof by the computer system, the main memory and the processing device also constituting machine-readable storage media. The machine-readable medium, data storage system, and/or main memory can correspond to the memory sub-system 110 of FIG. 1.

In one embodiment, the instructions include instructions to implement functionality discussed above (e.g., the operations described with reference to FIG. 1). While the machine-readable medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random-access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random-access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
providing, over a connection from a host interface of a memory sub-system, a first portion of the memory sub-system to a first host system as a memory device accessible via a first protocol and a second portion of the memory sub-system to the first host system as a storage device accessible via a second protocol;
writing, by the first host system running a first database manager and into the storage device via the second protocol, first database records;
storing, by the first host system running the first database manager and into the memory device via the first protocol, data identifying changes to second database records to be written into the storage device;
connecting the connection from the host interface of the memory sub-system to a second host system separate from the first host system to provide the second host system with access to the memory device via the first protocol and the storage device via the second protocol;
loading, by the second host system running a second database manager and according to the second protocol, the data identifying the changes to the second database records; and
servicing, by the second host system running the second database manager, database requests based on the first database records and the second database records.

2. The method of claim 1, wherein the connection is a computer express link connection.

3. The method of claim 2, wherein the connecting of the connection from the host interface of the memory sub-system to the second host system is in response to a failure of the first host system.

4. The method of claim 3, wherein the first protocol is configured for cache coherent memory access via load instructions and store instructions; and the second protocol is configured for storage access via read commands and write commands.

5. The method of claim 3, wherein the first protocol is configured to identify access locations via memory addresses at a first data granularity; and the second protocol is configured to identify access locations via logical block addresses at a second data granularity.

6. The method of claim 3, further comprising:
reconstructing, by the second host system, the second database records based on the data identifying the changes to the second database records.

7. The method of claim 6, wherein the data identifying the changes to the second database records includes write-ahead log entries.

8. The method of claim 6, wherein the data identifying the changes to the second database records includes simple sorted tables.

9. The method of claim 6, wherein the storage device provided by the memory sub-system contains no data representative of the second database records at a time of the failure of the first host system.

10. The method of claim 3, further comprising:
storing, by the first host system running the first database manager and into the memory device via the first protocol, at least a portion of the second database records; and
loading, by the second host system running the second database manager and according to the second protocol, the portion of the second database records.

11. A host system, comprising:
a memory configured to store instructions representative of a database manager;
a cache; and
a processing device configured to:
execute the instructions to run the database manager;
communicate, over a connection from a host interface of a memory sub-system to the host system to access:
a memory device attached by the memory sub-system to the host system via a first protocol via the cache for cache coherent memory access; and
a storage device attached by the memory sub-system to the host system via a second protocol for storage access;
execute load instructions to access, according to the second protocol, data identifying changes to second database records; and
service database requests based on first database records stored in the storage device and the second database records.

12. The host system of claim 11, wherein the connection is a computer express link connection.

13. The host system of claim 11, wherein the processing device is further configured to:
reconstruct the second database records based on the data identifying the changes to the second database records.

14. The host system of claim 13, wherein the data identifying the changes to the second database records includes write-ahead log entries, or simple sorted tables.

15. The host system of claim 14, wherein the storage device provided by the memory sub-system contains no data representative of the second database records at a time of the storage device being attached to the host system by the memory sub-system.

16. The host system of claim 11, wherein the processing device is further configured to:
load, according to the second protocol, at least a portion of the second database records from the memory device attached by the memory sub-system to the host system.

17. A non-transitory computer storage medium storing instructions which, when executed in a computing system, cause the computing system to perform a method, comprising:
running, in a host system of the computing system, a database manager;
communicating, over a connection from a host interface of a memory sub-system to the host system to access:
a memory device attached by the memory sub-system to the host system for cache coherent memory access via a first protocol; and
a storage device attached by the memory sub-system to the host system for storage access via a second protocol;
executing load instructions to access, according to the second protocol, data identifying changes to second database records; and
servicing database requests based on first database records stored in the storage device and the second database records.

18. The non-transitory computer storage medium of claim 17, wherein the connection is a computer express link connection.

19. The non-transitory computer storage medium of claim 17, wherein the method further comprises:
reconstructing the second database records based on the data identifying the changes to the second database records.

20. The non-transitory computer storage medium of claim 17, wherein the method further comprises:
executing load instructions to access, according to the second protocol, at least a portion of the second database records from the memory device attached by the memory sub-system to the host system.
